(19) United States
(12) Patent Application Publication
(10) Pub. No.: US 2026/0287819 A1
(43) Pub. Date: Sep. 24, 2026

(54) INTEGRATED OPTICAL DEVICE AND METHOD OF FORMING THE SAME

(71) Applicant: Taiwan Semiconductor Manufacturing Company, Ltd., Hsinchu (TW)

(72) Inventors: Sheng-Kai SU, Hsinchu City (TW); Tzu-Ang Chao, Hsinchu (TW)

(73) Assignee: Taiwan Semiconductor Manufacturing Company, Ltd., Hsinchu (TW)

(21) Appl. No.: 19/084,678

(22) Filed: Mar. 19, 2025

(51) Int. Cl. G02B 6/13; G02B 6/12; G02B 6/122; G02B 6/125

(52) U.S. Cl. CPC G02B 6/13; G02B 6/12007; G02B 6/1223; G02B 6/125; G02B 2006/12061; G02B 2006/12069; G02B 2006/12164

(57) ABSTRACT

An integrated optical device and method of forming the same are provided. The method includes the following steps. A porous structure is formed by assembling a plurality of bricks, wherein the porous structure includes a continuous hollow portion within a bulk material. A first material having a first refractive index is filled into the continuous hollow portion of the porous structure. The bulk material of the porous structure is replaced with a second material having a second refractive index. The second refractive index is less than the first refractive index.

### BACKGROUND

An integrated optical device may be configured to use optical signals for data transmission, since the light has properties of high speed, high bandwidth and low delay, which is advantageous in long-distance data transmission. Due to the long wavelength of photons, the size of an integrated optical device usually ranges from few hundred nanometers to few micrometers to confine the photons. Consequently, the inherent nature of photons makes two-dimensional scaling of an integrated optical device is a challenge.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic perspective view of a wavelength dividing structure according to an embodiment of the present disclosure.

FIG. 2 is a schematic perspective view of a wavelength dividing structure according to another embodiment of the present disclosure.

FIG. 3 is a schematic perspective view of a wavelength dividing structure according to another embodiment of the present disclosure.

FIG. 4 is a diagram illustrating transmittance versus wavelength of the optical signal of the output waveguides of the wavelength dividing structure.

FIG. 5 is a schematic perspective view of a wavelength dividing structure according to an embodiment of the present disclosure.

FIG. 6 is a schematic perspective view of a wavelength dividing structure according to another embodiment of the present disclosure.

FIG. 7 is a schematic perspective view of a wavelength dividing structure according to another embodiment of the present disclosure.

FIGS. 8A, 8B, 9A, 9B, 10-15 are schematic different views illustrating a method for forming an integrated optical device at various stages according to some embodiments of the present disclosure.

FIG. 16 is a schematic cross-sectional view of an integrated optical device according to an embodiment of the present disclosure.

FIG. 17 is a diagram of an integrated optical device according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, “around”, “about”, “approximately”, or “substantially” shall generally mean within 20 percent, or within 10 percent, or within 5 percent of a given value or range. Numerical quantities given herein are approximate, meaning that the term “around”, “about”, “approximately”, or “substantially” can be inferred if not expressly stated.

According to embodiments of the present disclosure, an integrated optical device and a method of forming the same are described. The integrated optical device of the disclosure includes a three-dimensional (3D) wavelength dividing structure rather than the conventional two-dimensional (2D) wavelength dividing structure. The conventional two-dimensional wavelength dividing structure has multiple output waveguides arranged horizontally side by side, which occupy a large area and waste the footprint of the device.

In the disclosure, three-dimensional wavelength dividing structure can divide and combine the light with various wavelengths in a three-dimensional scheme. Specifically, the three-dimensional wavelength dividing structure includes multiple output waveguides arranged at different horizontal levels, so that the vertical space is efficiently utilized, and the size of the wavelength dividing structure and therefore the integrated optical device can be significantly reduced.

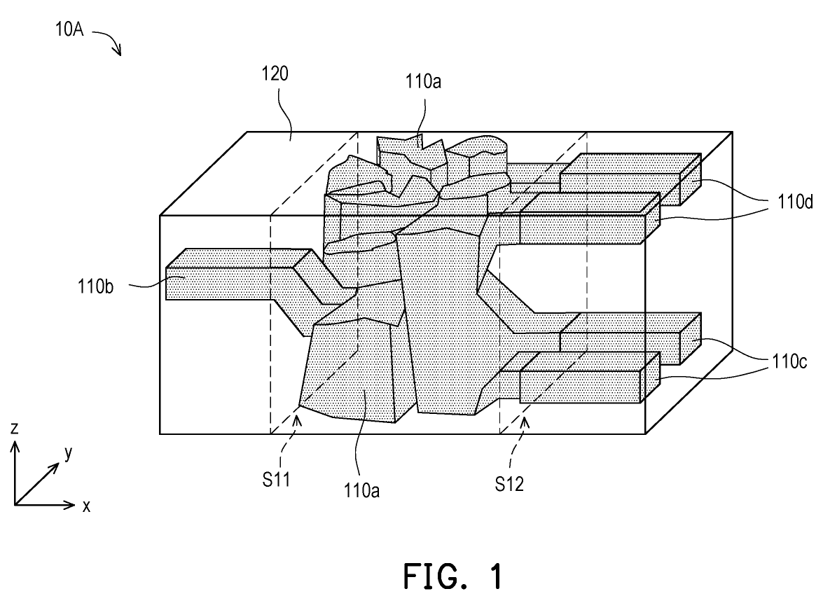

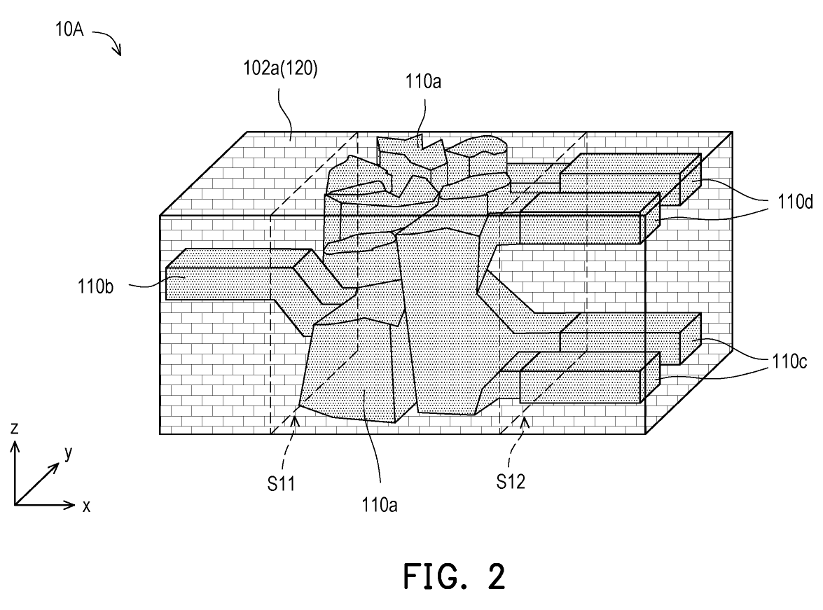

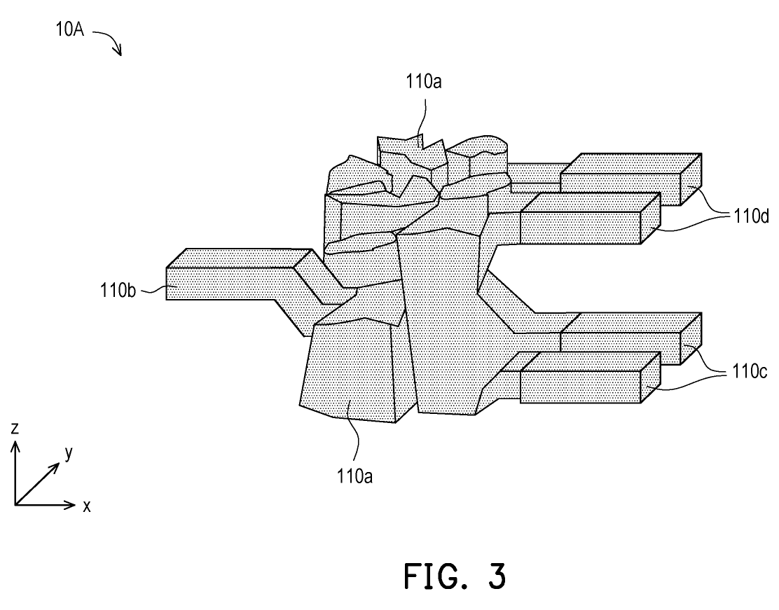

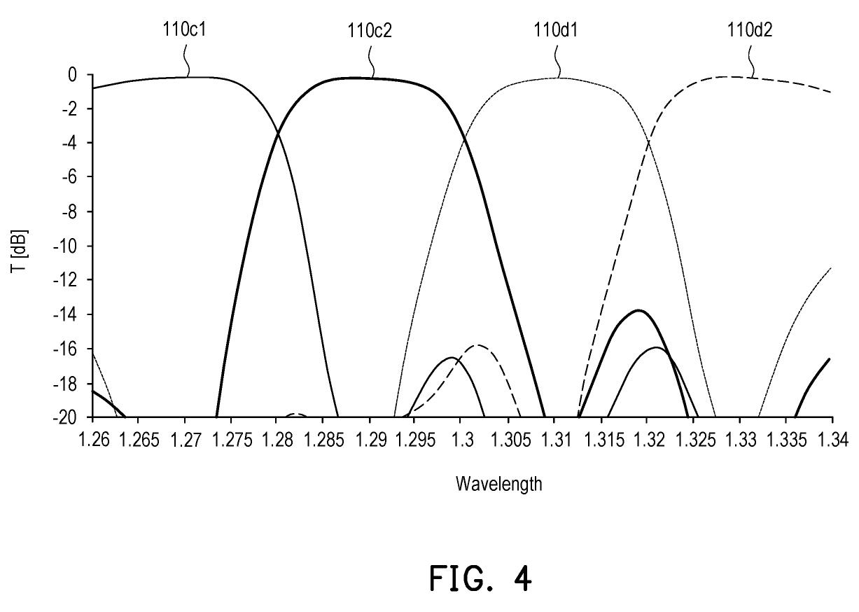

FIG. 1 is a schematic perspective view of a wavelength dividing structure 10A according to an embodiment of the present disclosure. FIG. 2 is a schematic perspective view of a wavelength dividing structure 10A according to another embodiment of the present disclosure. FIG. 3 is a schematic perspective view of a wavelength dividing structure 10A according to another embodiment of the present disclosure. FIG. 4 is a diagram illustrating transmittance versus wavelength of the optical signals of the output waveguides of the wavelength dividing structure 10A.

Referring to FIG. 1, a wavelength dividing structure 10A includes a wavelength dividing body 110a, an input waveguide 110b and at least two output waveguides (including first output waveguides 110c and second output waveguides 110d). In the present embodiment, the wavelength dividing structure 10A is a demultiplexer configured to divide wavelengths, modes or split power depending on the application. The three-dimensional wavelength dividing structure is referred to as a “three-dimensional wavelength-division multiplexing (3D WDM) structure” in some examples. In some embodiments, the wavelength dividing body 110a is configured to split an input beam into multiple output beams. The input beam may have a broadband wavelength, and the output beams may have narrowband wavelengths. In this case, the input waveguide 110b is configured to transfer the input beam (i.e. a wavelength broadband beam), and the output waveguides (including first output waveguides 110c and second output waveguides 110d) are configured to transfer the output beams (i.e. wavelength narrowband beams), so that the input beam may enter from the input waveguide 110b, divide through wavelength dividing body 110a to form multiple output beams, and then the output beams exit from the output waveguides (including first output waveguides 110c and second output waveguides 110d), respectively. The three-dimensional wavelength dividing structure 10A includes multiple output waveguides arranged at different horizontal levels, so that the vertical space is efficiently utilized, and the size of the wavelength dividing structure and the integrated optical device can be significantly reduced. The detailed configuration of the wavelength dividing structure 10A is described in the following.

The input waveguide 110b extending along a first direction (e.g., x direction) is connected to one side S11 of the wavelength dividing body 110a. The output waveguides (including first output waveguides 110c and second output waveguides 110d) extending along the first direction (e.g., x direction) are connected to an opposite side S12 of the wavelength dividing body 110a. Specifically, the wavelength dividing body 110a is connected between the input waveguide 110b and the output waveguides (including first output waveguide 110c and second output waveguide 110d).

In some embodiments, the first output waveguides 110c and the second output waveguides 110d are located at different horizontal levels. For example, the first output waveguides 110c are arranged along a second direction (e.g., y direction) different from (e.g., perpendicular to) the first direction (e.g., x direction) and located at a first horizontal level. The second output waveguides 110d are arranged along the second direction (e.g., y direction) and located at a second horizontal level different from (e.g., higher than) the first horizontal level of the first output waveguides 110c. Specifically, the second output waveguides 110d are spaced apart from each other in the second direction (e.g., y direction), the first output waveguides 110c are spaced apart from each other in the second direction (e.g., y direction), and the second output waveguides 110d are spaced apart from the first output waveguides 110c in a third direction (e.g., z direction) different from the first direction (e.g., x direction) and the second direction (e.g., y direction). In the specification, the first direction and the x direction may be interchangeably used, the second direction and the y direction may be interchangeably used, and the third direction and the z direction may be interchangeably used.

In some embodiments, the horizontal level of the input waveguide 110b is different from the horizontal levels of the first output waveguides 110c and the second output waveguides 110d. However, the present disclosure is not limited thereto. In other embodiments, the horizontal level of the input waveguide 110b may be the same as the horizontal level of the first output waveguides 110c or the horizontal level of the second output waveguides 110d.

In some embodiments, the wavelength dividing body 110a has an irregular three-dimensional (3D) structure including multiple 3D optical paths in the 3D space formed by combination of x-direction optical paths, y-direction optical paths and/or z-direction optical paths connected to each other. In some embodiments, the 3D optical paths of the wavelength dividing body 110a are designed to split an input beam (receiving from the input waveguide 110b) into multiple output beams (travelling to the output waveguides 110d and 110c). The 3D optical paths of the wavelength dividing body 110a are continuous and connected to the input waveguide 110b and the output waveguides 110c and 110d at opposite sides.

The material of each of the wavelength dividing body 110a, the input waveguide 110b and the output waveguides 110c and 110d includes a refractive index greater than or equal to about 2. For example, the material of each of the wavelength dividing body 110a, the input waveguide 110b, and the output waveguides 110c and 110d includes silicon, silicon nitride or other suitable materials.

In some embodiments, the material of the wavelength dividing body 110a is the same as the materials of the input waveguide 110b and the output waveguides 110c and 110d. However, the disclosure is not limited thereto. In other embodiments, the material of the wavelength dividing body 110a may be different from the materials of the input waveguide 110b and the output waveguides 110c and 110d.

In some embodiments, the wavelength dividing structure 10A is void-free, but the disclosure is not limited thereto. In other embodiments, the wavelength dividing structure 10A may have few small voids. The size of the small voids is less than or equal to about 5 nm, and thus, the voids would not affect the dividing of wavelengths of the wavelength dividing body 110a.

In some embodiments, the minimum size of each of the 3D optical paths of the wavelength dividing body 110a is about 50 nm or more, so as reduce large voids (such as having a size larger than 5 nm) formed in the wavelength dividing body 110a.

In some embodiments, the wavelength dividing structure 10A further includes a cladding structure 120 surrounding the wavelength dividing body 110a, the input waveguide 110b, and the output waveguides 110c and 110d. The refractive index of the cladding structure 120 is less than the refractive index of the wavelength dividing body 110a, the refractive index of the input waveguide 110b and the refractive index of the output waveguides 110c and 110d.

In some embodiments, the material of the cladding structure 120 has the refractive index lower than about 2. For example, the material of the cladding structure 120 includes silicon oxide (as shown in FIG. 1), nucleic acids (as shown in FIG. 2), air (as shown in FIG. 3) or other suitable materials.

In an embodiment where the material of the cladding structure 120 includes nucleic acids as shown in FIG. 2, the nucleic acids may be paired to form a plurality of bricks 102a. The bricks 102a may be connected to each other by chemical bonding, for example, hydrogen bonds. In some embodiments, the nucleic acids include deoxyribonucleic acid (DNA), ribonucleic acid (RNA) or the like.

In an embodiment where the material of the cladding structure 120 includes air as shown in FIG. 3, the wavelength dividing body 110a, the input waveguide 110b, and the output waveguides (including first output waveguides 110c and second output waveguides 110d) are exposed to the outer environment.

In some embodiments, the first output waveguides 110c and second output waveguides 110d are configured to transfer the wavelength narrowband beams with different central wavelengths, for example, as shown in FIG. 4. In some embodiments, one of the first output waveguides 110c (labeled as 110c1) has high transmittance at the central wavelength around 1.27 μm. Another one of the first output waveguides 110c (labeled as 110c2) has high transmittance at the central wavelength around 1.29 μm. One of the second output waveguides 110d (labeled as 110d1) has high transmittance at the central wavelength around 1.31 μm. Another one of the second output waveguides 110d (labeled as 110d2) has high transmittance at the central wavelength around 1.33 μm. In this way, a large amount of information can be carried and transferred through the wavelength dividing structure 10A by utilizing different wavelengths or modes of light, and thereby the density and degree of freedom of the optical device can be increased.

Please note, for ease of the description, in the present embodiment, the wavelength dividing structure 10A is a demultiplexer, so that the waveguide 110b is named the input waveguide 110b, and the waveguides 110c and 110d are named the first output waveguides 110c and the second output waveguides 110d, respectively. However, the present disclosure is not limited thereto. In other embodiments, the wavelength dividing structure 10A may be a multiplexer configured to combine different wavelengths, modes or power depending on the application.

In an embodiment where the wavelength dividing structure 10A is a multiplexer, the wavelength dividing body 110a is configured to combine multiple input beams into a single output beam, wherein the input beams may have narrowband wavelengths, and the output beam may have a broadband wavelength. In this case, the waveguide 110b may be configured to transfer the output beam (i.e. a wavelength broadband beam) and may be named as the output waveguide. The waveguides 110c and 110d may be configured to transfer the input beams (i.e. wavelength narrowband beams), and may be named as the input waveguides. Therefore, multiple input beams may enter from the waveguides 110c and 110d, join through wavelength dividing body 110a to form the output beam, and then the output beam exits from the waveguide 110b.

The above embodiments of FIGS. 1-3 in which four output waveguides are provided for illustration purposes, and are not construed as limiting the disclosure. In other words, the number of output waveguides and their arrangement are not limited by the disclosure and can be adjusted according to actual requirements.

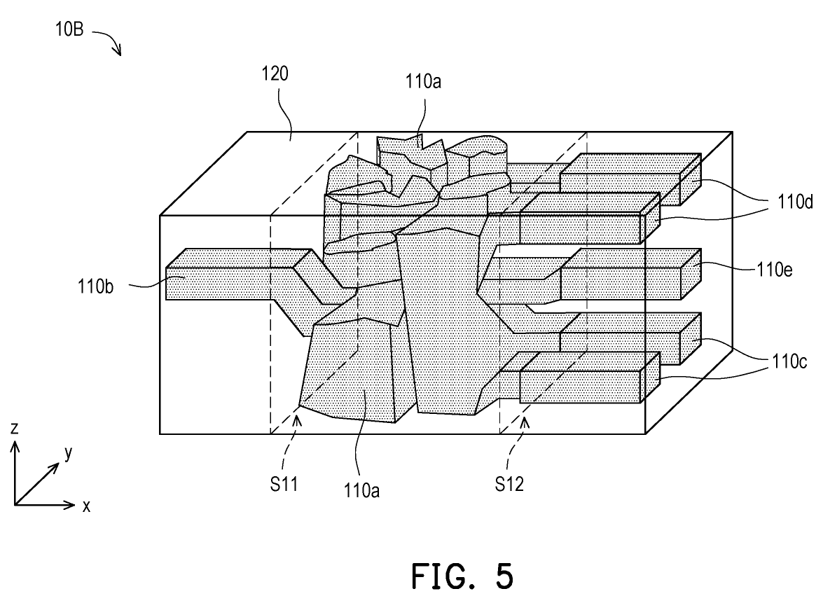

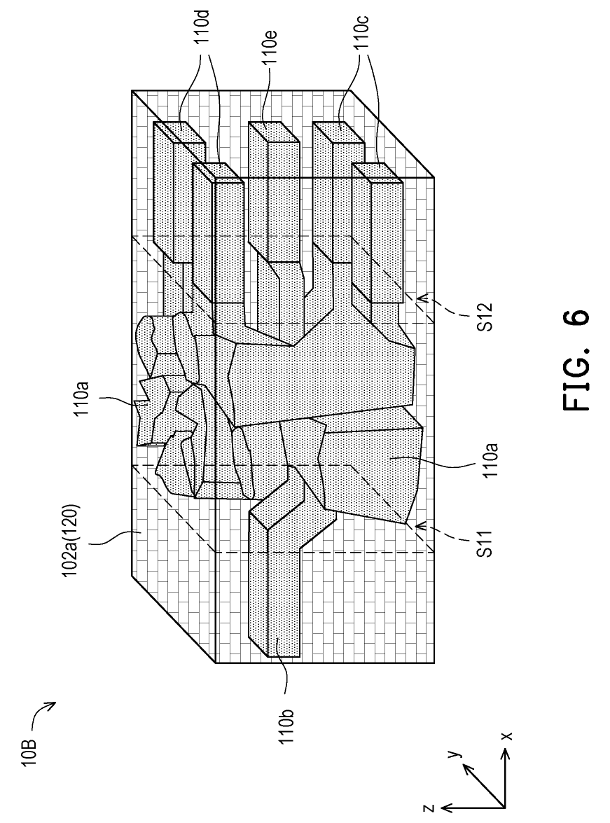

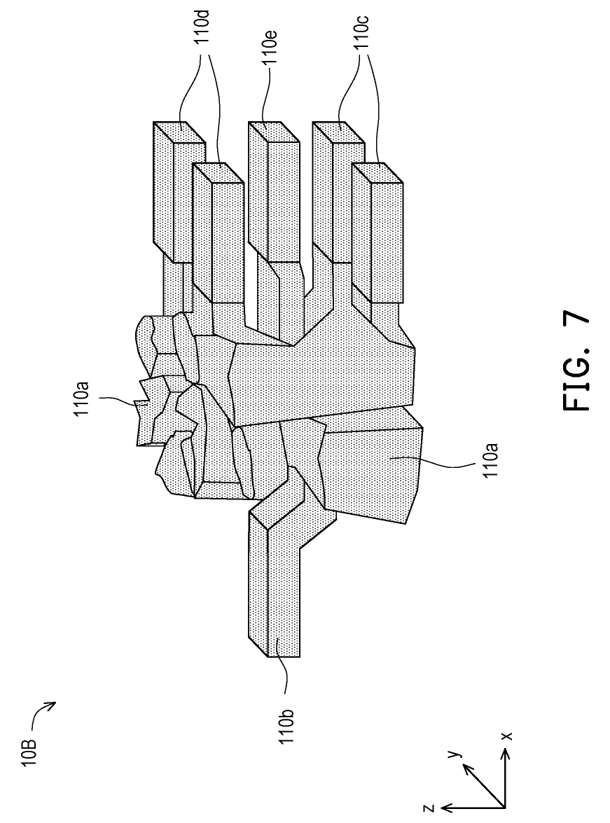

FIG. 5 is a schematic perspective view of a wavelength dividing structure 10B according to another embodiment of the present disclosure. FIG. 6 is a schematic perspective view of a wavelength dividing structure 10B according to another embodiment of the present disclosure. FIG. 7 is a schematic perspective view of a wavelength dividing structure 10B according to another embodiment of the present disclosure. It should be noted herein that, in embodiment provided in FIGS. 5-7, element numerals and partial content of the embodiments provided in FIGS. 1-3 are followed, the same or similar reference numerals being used to represent the same or similar elements, and description of the same technical content being omitted. For a description of an omitted part, reference may be made to the foregoing embodiments, and the descriptions thereof are omitted herein.

Referring to FIGS. 5-7, the wavelength dividing structure 10B shown in FIGS. 5-7 is similar to the wavelength dividing structure 10A shown in FIGS. 1-3, and the difference between the wavelength dividing structure 10B and the wavelength dividing structure 10A lies in that, the wavelength dividing structure 10B further includes at least one third output waveguide 110e. The third output waveguide 110e extends along the first direction (e.g., x direction) and is connected to the side S12 of the wavelength dividing body 110a. The first output waveguides 110c, the second output waveguides 110d, and the third output waveguide 110e are at different horizontal levels. For example, the third output waveguide 110e is located between the first output waveguides 110c and the second output waveguides 110d. However, the present disclosure is not limited. In an embodiment, the third output waveguide 110e may be located above or below the output waveguides 110c and 110d. Besides, the number of third output waveguides 110e is not limited by the disclosure. For example, there may be multiple third output waveguides 110e spaced apart in the second direction (e.g., y direction).

Similar to the first output waveguides 110c and the second output waveguides 110d, the third output waveguide 110e is configured to transfer a wavelength narrowband beam which has a central wavelength different from the central wavelengths transferred by the first output waveguides 110c or the second output waveguides 110d.

In some embodiments, the cladding structure 120 also surrounds the third output waveguide 110e, and the refractive index of the cladding structure 120 is less than a refractive index of the third output waveguide 110e. For example, the material of the cladding structure 120 includes silicon oxide (as shown in FIG. 5), nucleic acids (as shown in FIG. 6), air (as shown in FIG. 7) or other suitable materials, which are similar to the embodiments shown in FIGS. 1-3.

The wavelength dividing structure 10A and the wavelength dividing structure 10B include multiple output waveguides arranged at different horizontal levels, this allows for more efficient use of vertical space, and thereby the sizes of the wavelength dividing structure 10A and the wavelength dividing structure 10B can be significantly reduced.

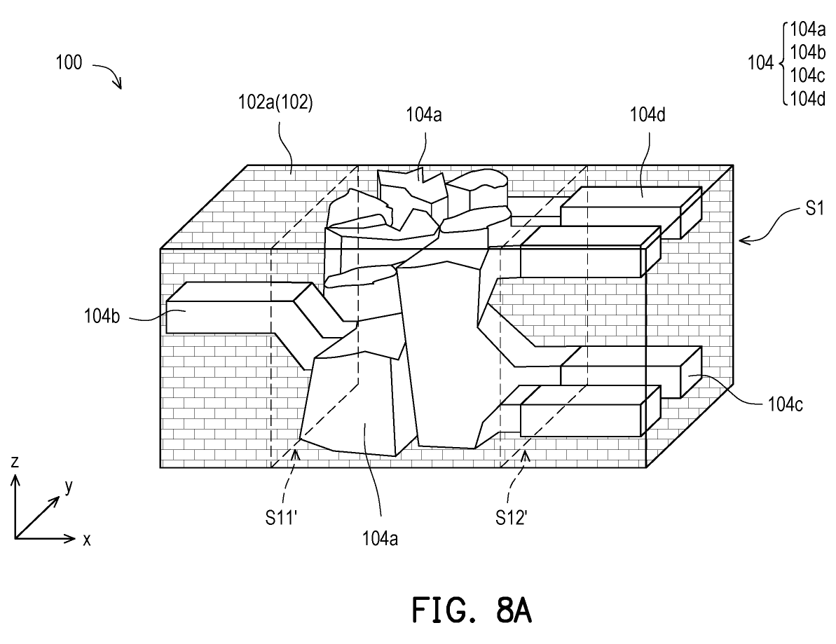

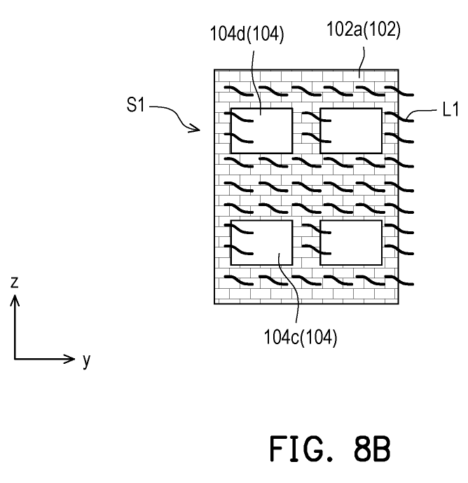

FIGS. 8A,8B, 9A, 9B, 10-15 are schematic different views illustrating a method for forming the integrated optical device 1 at various stages according to some embodiments of the present disclosure. Herein, in embodiment provided in FIGS. 8A,8B, 9A, 9B, 10-15, element numerals and partial content of the embodiments provided in FIG. 1 are followed, the same or similar reference numerals being used to represent the same or similar elements, and description of the same technical content being omitted. For a description of an omitted part, reference may be made to the foregoing embodiment, and the descriptions thereof are omitted herein.

Referring to FIGS. 8A and 8B, a first structure 100 is provided. FIG. 8A is a schematic perspective view of the first structure 100 and FIG. 8B is a schematic view of a surface S1 of the first structure 100.

The first structure 100 is a porous structure including a continuous hollow portion 104 within a bulk material 102. In some embodiments, the hollow portion 104 includes a wavelength dividing channel 104a, an input channel 104b and multiple output channels 104c and 104d. The input channel 104b is connected to one side S11’ of the wavelength dividing channel 104a. The output channels 104c and 104d are connected to an opposite side S12’of the wavelength dividing channel 104a. In some embodiments, the wavelength dividing channel 104a is configured to form a wavelength dividing body 110a in the subsequent process. The input channel 104b is configured to form an input waveguide 110a in the subsequent process. The output channels 104c and 104d are configured to form output waveguide 110c and 110d in the subsequent process.

In some embodiments, the first structure 100 may be designed by a software-assisted inverse 3D design to determine the 3D geometry of the first structure 100. In the software-assisted inverse 3D design based on specific figure-of-merit (FOM), a complex 3D geometry is designed with a constraint ensuring the high index regions connected each other and with minimum feature size constraint (e.g. >= 50 nm) based on the process. The constraints with dimensions of a few tens of nanometers are still much smaller than the wavelength of light, and therefore will not significantly impact the results. For example, the 3D geometry of the first structure 100 may be calculated by a software according to materials of first structure and the wavelength dividing structure to be formed, wavelengths of input beam and output beams, boundary conditions (for example, number of input/output waveguides, size of the wavelength dividing structure or the like), process constraints and etc. The process constraints may be related to the process capability, so that the calculated structure may be able to be fabricated in practical. In some embodiments, during the design stage of the first structure 100, the size of the hollow portion 104 of the first structure 100 is designed to be about 50 nm, 150 nm or more, such that the deposition process can fills the material into the hollow portion 104 easily.

In some embodiments, the first structure 100 is assembled by a plurality of bricks 102a to form the designed 3D geometry. The bricks 102a are connected to build up a skeleton portion of the porous structure. Specifically, the bulk material 102 of the first structure 100 is made of the bricks 102a.

In some embodiments, the bricks 102a are assembled together by chemical bonding. For example, each brick 102a is assembled by base pairs of nucleic acids and the connection between different bricks 102a may be achieved by hydrogen bonds. In some embodiments, each brick may be assembled by 8 base pairs of nucleic acids, and may have dimensions of 2.5 nm by 2.5 nm by 2.7 nm. In some embodiments, the nucleic acids include deoxyribonucleic acid (DNA), ribonucleic acid (RNA) or the like. In some embodiments, each brick 102a may have the same or different sequences of nucleic acids. The DNA bricks are stacked in a bottom-up manner, which is benefit to fabricate sophisticated 3D features. Specifically, the bottom-up DNA brick stacking is a method for constructing nanoscale structures using DNA as a building material. This approach involves creating complex 3D shapes by assembling short, single-stranded DNA segments, called "bricks," which can be designed to self-assemble into specific shapes based on complementary base pairing.

In some embodiments, the sequences of the nucleic acids in each bricks 102a are configured to form the designed 3D geometry by using the sequence pairing properties of nucleic acids. Taking a DNA strand as an example, the DNA strand may have a DNA sequence arranging by nucleotide bases, such as adenine (A), cytosine (C), guanine (G), and thymine (T), wherein A is complementary to T, and C is complementary to G. Accordingly, when the sequence of the DNA strand in one brick 102a is complementary to the sequence of the DNA strand in another brick 102a, the two bricks 102a are connected together. Contrarily, when a sequence of a DNA strand in one brick 102a is not complementary to a sequence of a DNA strand in another brick 102a, the two bricks 102a are not connected. Therefore, through the pairing mechanism of nucleic acids, some surfaces of the bricks 102a are connected to form the bulk material 102 and some surfaces of the bricks 102a are not connected to form the hollow portion in the bulk material 102.

In other embodiments, the bricks 102a may be assembled together by mechanical engagement. For example, some bricks 102a may have protrusion portions and another bricks 102a may have recess portions. The protrusion portions of the bricks 102a correspond to and engaged in the recess portions of the bricks 102a, so as to form the first structure 100. Such mechanism may be referred to as a LEGO-like stacking mode.

In some embodiments, the bulk material 102 has a plurality of first connection parts L1 on a surface S1 of the first structure 100, as shown in FIG. 8B. The first connection parts L1 are configured for connection with another component (such as the second structure 200 described below) in the subsequent process.

In some embodiments, each first connection part L1 has a first single-strand DNA. In an embodiment where the bricks 102a are assembled by nucleic acids, the first connection parts L1 are derived from the nucleic acids constituting the brick 102a. In an embodiment where the bricks 102a are assembled by mechanical engagement, the first connection parts L1 may be formed by performing a surface modification process to the surface S1 of the first structure 100, similar to the formation of the second connection parts L2 of the second structure 200 described later. For example, a self-assembled monolayer including the first connection parts L1 may be formed on the surface S1.

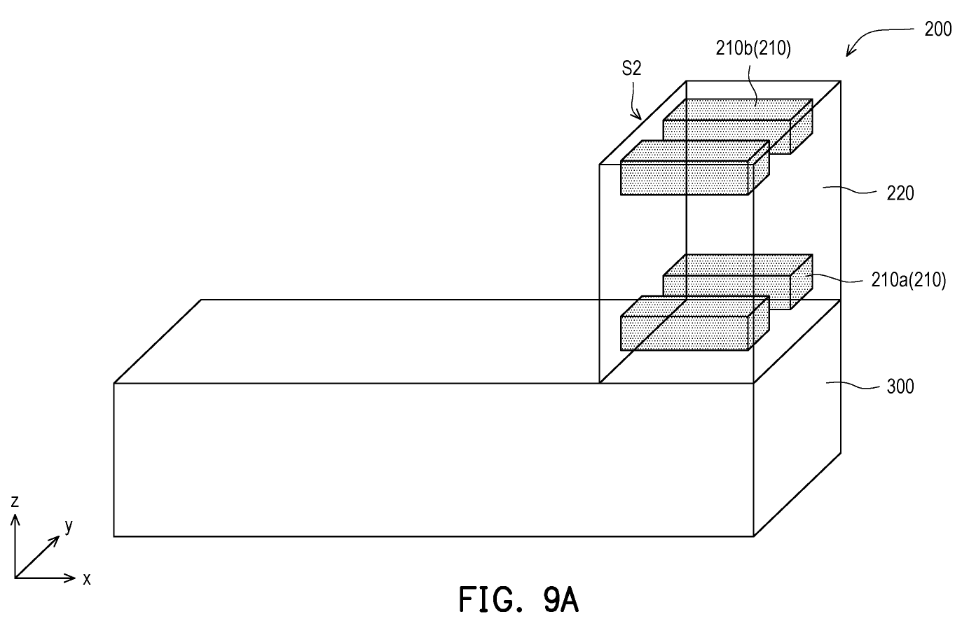

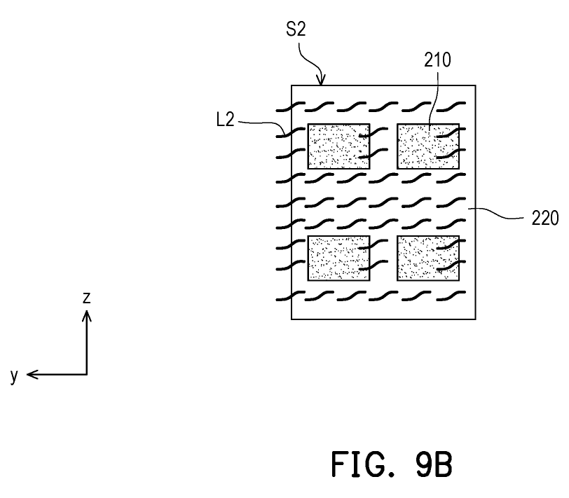

Referring to FIGS. 9A and 9B, a second structure 200 is provided over a substrate 300. FIG. 9A is a schematic perspective view of the second structure 200 and the substrate 300, and FIG. 9B is a schematic view of a surface S2 of the second structure 200.

In some embodiments, the substrate 300 may be a semiconductor substrate, such as a silicon substrate, a silicon on insulator (SOI) substrate or other suitable semiconductor substrates.

The second structure 200 includes a photonic integrated circuit (PIC) that contains a plurality of connecting waveguides 210 embedded in a dielectric layer 220. In some embodiments, the connecting waveguides 210 include first connecting waveguides 210a and second connecting waveguides 210b. The first connecting waveguides 210a are arranged along the second direction (e.g., y direction) and located at a first horizontal level. The second connecting waveguides 210b are arranged along the second direction (e.g., y direction) and located at a second horizontal level different from (e.g., higher than) the first horizontal level of the connecting waveguides 210a. Specifically, the second connecting waveguides 210b are spaced apart from each other in the second direction (e.g., y direction), the first connecting waveguides 210a are spaced apart from each other in the second direction (e.g., y direction), and the second connecting waveguides 210b are spaced apart from the first connecting waveguides 210a in the third direction (e.g., z direction).

In some embodiments, the second structure 200 may be formed by the following steps. First, a first dielectric material layer is deposited over the substrate 300. Then a waveguide material layer is deposited on the first dielectric material layer and patterned to form the first connecting waveguides 210a. A second dielectric material layer is deposited on the first dielectric material layer and covers the first connecting waveguides 210a. Thereafter, another waveguide material layer is deposited on the second dielectric material layer and patterned to form the second connecting waveguides 210b. Finally, a third dielectric material layer is deposited on the second dielectric material layer and covers the second connecting waveguides 210b. The first, second and third dielectric material layers collectively form the dielectric layer 220. In some embodiments, the deposition methods may include chemical vapor deposition (CVD), physical vapor deposition (PVD), atom layer deposition (ALD) or other suitable deposition methods. In some embodiments, the patterning method may include photolithography and etching processes.

In some embodiments, the refractive index of the connecting waveguides 210 is greater than the refractive index of the dielectric layer 220. In some embodiments, the material of the connecting waveguides 210 has a refractive index greater than or equal to about 2. For example, the material of the connecting waveguides 210 includes silicon, silicon nitride or other suitable materials. In some embodiments, the material of the dielectric layer 220 has a refractive index lower than about 2. For example, the material of the dielectric layer 220 includes silicon oxide or other suitable materials.

In some embodiments, the connecting waveguides 210a and 210b are configured to correspond to the output channels 110c and 110d of the first structure 100, respectively. The number of the connecting waveguides 210a and 210b is the same as the number of the output channels 110c and 110d.

In some embodiments, the second structure 200 has a plurality of second connection parts L2, as shown in FIG. 9B. The second connection parts L2 are configured for connection with the first connection parts L1 of the first structure 100 in the subsequent process. In some embodiments, each second connection part L2 has a second single-strand DNA. The second single-strand DNA is configured to pair with the first single-strand DNA of the first connection parts L1. Therefore, at least a portion of the second single-strand DNA is complementary with at least a portion of the first single-strand DNA.

In some embodiments, the second connection parts L2 of the second structure 200 are formed by performing a surface modification to add bonding groups to a surface S2 of the dielectric layer 220. In some embodiments, the surface modification may have high selectivity between the connecting waveguides 210 and the dielectric layer 220, so the second connection parts L2 are formed on the dielectric layer 220 but not formed on the connecting waveguides 210.

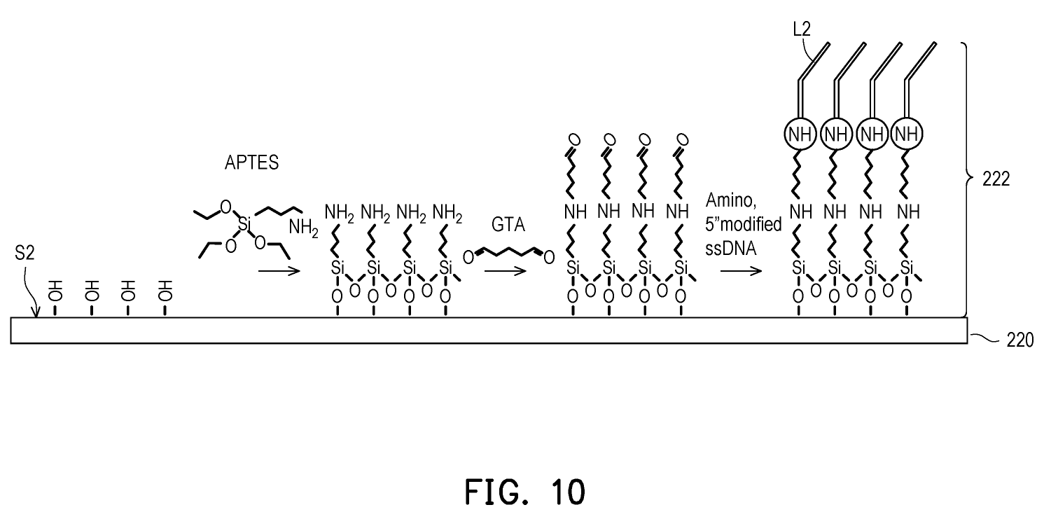

In some embodiments, the surface modification process includes forming a self-assembled monolayer 222 including the second connection parts L2 on the surface S2 of the dielectric layer 220, as shown in FIG. 10.

Referring to FIG. 10, an example of the surface modification process on the surface S2 of the dielectric layer 220 is schematically shown. First, a hydroxylation process is performed to form hydroxyl groups on the surface S2 of the dielectric layer 220. For example, the surface S2 of the dielectric layer 220 may be hydroxylated by H₂SO₄ and H₂O₂ solution. Then, a coupling agent (such as 3-aminopropyltriethoxysilane (APTES)) is coupled to the hydroxylated surface S2 by, for example, a silanization reaction to allow further attachment of functional groups on the terminal groups thereof. Next, another coupling agent (such as Glutaraldehyde (GTA)) is coupled to APTES through the terminal amine group of APTES to allow further attachment of DNA strand (e.g., the second connection part L2) on the terminal groups thereof. Finally, a DNA strand (such as amino, 5” modified ssDNA) is coupled to GTA through aldehyde terminal group of GTA to form the second connection parts L2 on the surface S2. It is appreciated that the type of the DNA strand of each second connection part L2 is not limited by FIG. 10, and it can be adjusted based on the structural design.

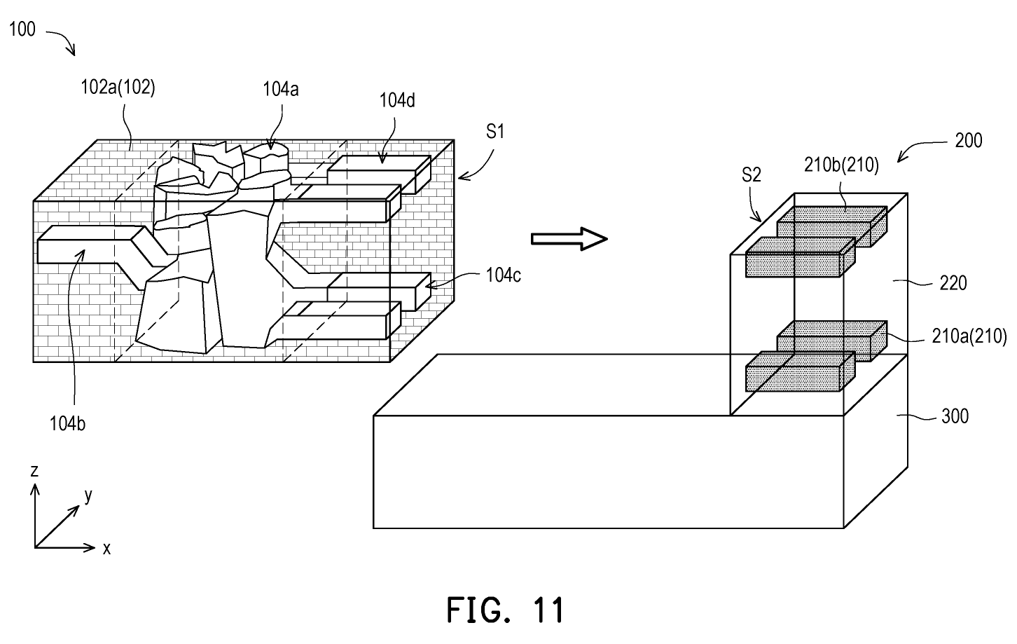

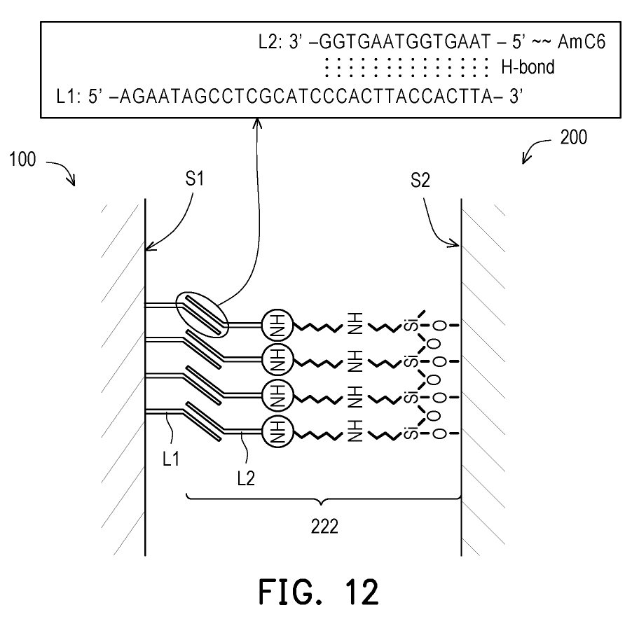

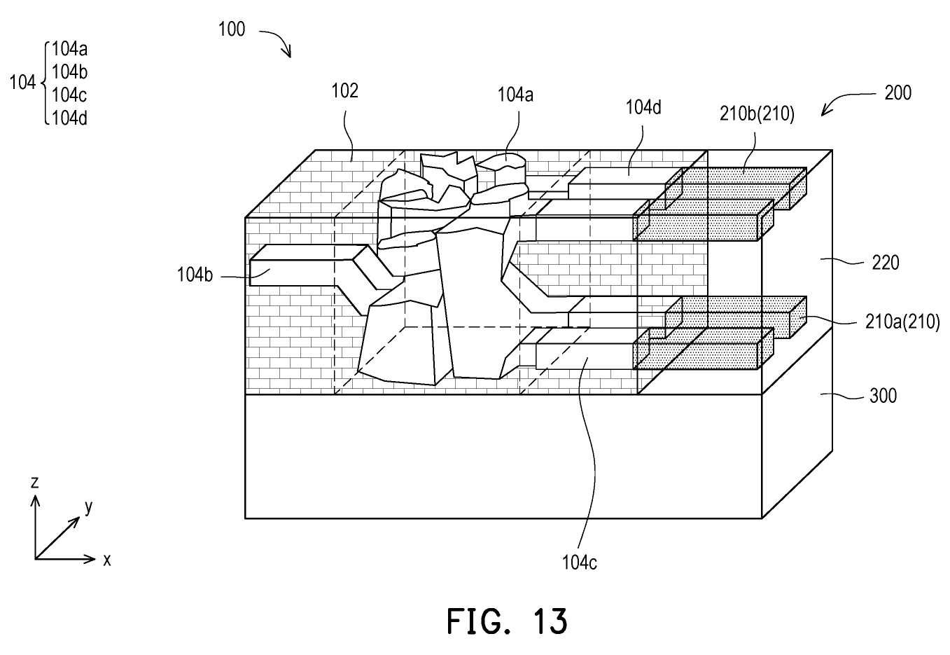

Referring to FIGS. 11-13, the first structure 100 is connected to the second structure 200 through the first connection parts L1 and the second connection parts L2. FIG. 11 is a schematic perspective view of connecting the first structure 100 to the second structure 200. FIG. 12 is a schematic enlargement view of the connection between the surface S1 of the first structure 100 and the surface S2 of the second structure 200. FIG. 13 is a schematic perspective view of the first structure 100 to the second structure 200 after connection.

In some embodiments, the first structure 100 is connected to the second structure 200 by self-assembly. Since the first connection parts L1 and the second connection parts L2 have complementary sequences, chemical bonds (such as hydrogen bonds or the like) may be formed between the first connection parts L1 and the second connection parts L2 to connect the first structure 100 and the second structure 200. For example, as shown in FIG. 12, the first connection part L1 is 5’-AGAATAGCCTCGCATCCCACTTACCACTTA-3’. The second connection part L2 is 3’-GGTGAATGGTGAAT-5’~~AmC6. The sequence “CCACTTACCACTTA” in the first connection part L1 is paired with the sequence “GGTGAATGGTGAAT” in the second connection part L2, so that hydrogen bonds are formed between the pairing sequences to connect the surface S1 of the first structure 100 to the surface S2 of the second structure 200. Please note that the DNA sequences of the first connection parts L1 and the second connection parts L2 in FIG. 12 are just a schematic example but not intended to limit the present disclosure. The DNA sequences of the first connection parts L1 and the second connection parts L2 can be adjusted by actual need, as long as the DNA sequence of the first connection parts L1 is at least partially complementary with the DNA sequence the second connection parts L2.

After the first structure 100 is connected to the second structure 200, the first connecting waveguides 210a may correspond to the output channels 104c and the second connecting waveguides 210b may correspond to the output channels 104d of the first structure 100, as shown in FIG. 13.

The first structure 100 (e.g., 3D WDM) is connected to the second structure 200 (e.g. PIC) by utilizing the complementary hybridization (i.e., specific pairing) of DNA for precise alignment. By using SAMs with high selectivity between high-index (e.g., Si, SiN) and low-index (e.g., SiO2) materials, we can position DNA at specific locations (e.g. only in SiO₂) on the processed PICs to pair with the DNA used in the first structure 100 (e.g., 3D WDM). Thus, the first structure 100 (e.g., 3D WDM) can be transferred and aligned with the waveguides connected to the PIC in the second structure 200.

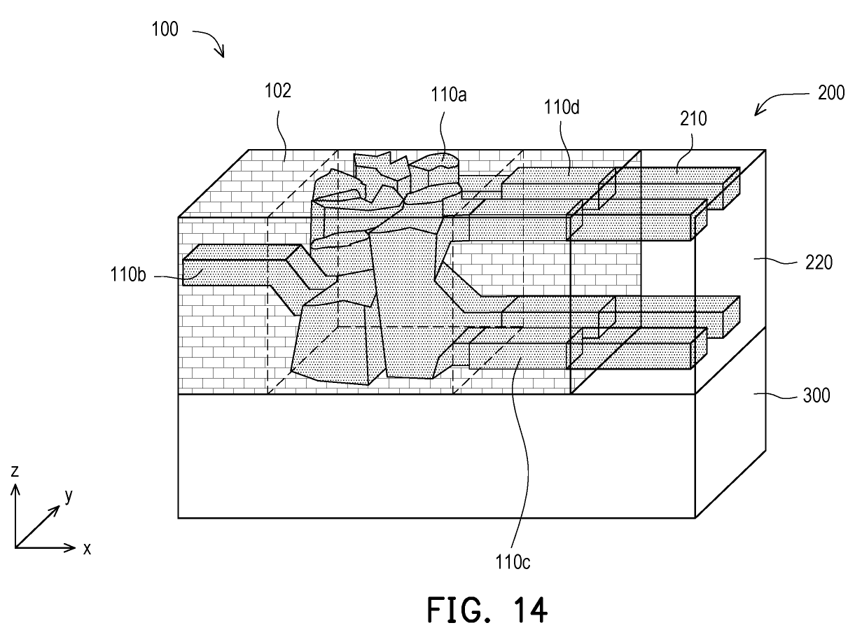

Referring to FIG. 14, a first material having a first refractive index is filled into the continuous hollow portion 104 of the first structure 100, so as to form a wavelength dividing body 110a in the wavelength dividing channel 104a, an input waveguide 110b in the input channel 104b, and the first output waveguides 110c and the second output waveguides 110d in the output channels 104c and 104d, respectively. Since the output channels 104c and 104d correspond to the connecting waveguides 210 of the second structure 200, the first output waveguides 110c and the second output waveguides 110d are in direct contact with the corresponding connecting waveguides 210.

In some embodiments, the first refractive index is greater than or equal to about 2. For example, the first material may include silicon, silicon nitride or other suitable materials.

In some embodiments, the first material may be deposited in the hollow portion 104 and on the first structure 100 by chemical vapor deposition (CVD), flow CVD, atom layer deposition (ALD) or other suitable methods. In some embodiments, after the deposition of the first material, a removing process (such as etching, chemical mechanical polishing (CMP), or the like) may be performed to remove the excess portion of the first material outside of the first structure 100.

In some embodiments, the first material is substantially filled up the hollow portion 104 of the first structure 100. In some embodiments, one or more voids (not shown) may be formed during the filling of the first material. In some embodiments, the size of the void is about 5 nm or lower.

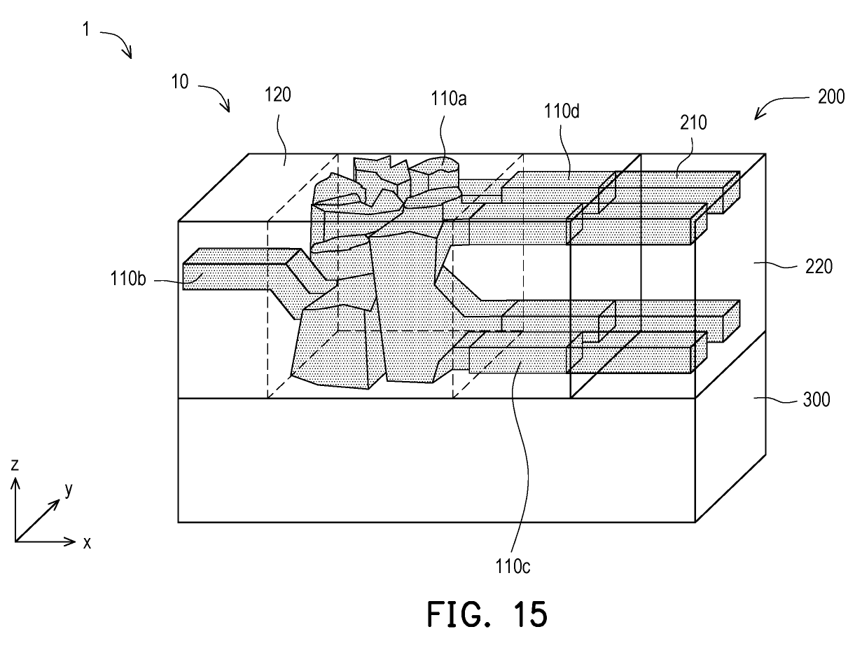

Referring to FIG. 15, after filling the first material, the bulk material 102 of the first structure 100 is replaced with a second material having a second refractive index. For example, the bulk material 102 is removed from the first structure 100 first, so that the wavelength dividing body 110a, the input waveguide 110b, the first output waveguides 110c and the second output waveguides 110d are exposed. In some embodiments, the bulk material 102 is removed by an etching process (such as a wet etching process or a dry etching process) or other suitable method. The etchant used for the etching process may include H₂O₂ or other suitable materials. Then, the second material is deposited over the substrate 300 to form a cladding structure 120 surrounding the wavelength dividing body 110a, the input waveguide 110b, the first output waveguides 110c and the second output waveguides 110d. In this case, the cladding structure 120, the wavelength dividing body 110a, the input waveguide 110b, the first output waveguides 110c and the second output waveguides 110d collectively form a wavelength dividing structure 10. In some embodiments, the second material is deposited over the substrate 300, the wavelength dividing body 110a, the input waveguide 110b, the first output waveguides 110c and the second output waveguides 110d by chemical vapor deposition (CVD), flow CVD, atom layer deposition (ALD) or other suitable methods.

In some embodiments, the second refractive index is less than the first refractive index. For example, the second refractive index is lower than about 2. In some embodiments, the second material may include silicon oxide or other suitable materials.

In an embodiment, in the stage after filling the first material and before removing the bulk material 102 from the first structure 100, the bulk material 102 can be regarded as the cladding structure 120 of the wavelength dividing structure 10, which is similar to the structure described in FIG. 2.

In an embodiment, in the stage after removing the bulk material 102 from the first structure 100 and before depositing the second material, the wavelength dividing body 110a, the input waveguide 110b, the first output waveguides 110c and the second output waveguides 110d are surrounded by air. In this case, the cladding structure 120 of the wavelength dividing structure 10 is air, which is similar to the structure described in FIG. 3.

Based on the above, an integrated optical device 1 is substantially fabricated. By using the aforementioned method, the complex structure of the wavelength body 110a may be easily formed and the space can be efficiently used, such that a three-dimensional structure of the wavelength dividing structure 10 can be achieved, and thereby the size of the wavelength dividing structure 10 and therefore the integrated optical device 1 can be significantly reduced.

Referring to FIG. 15, the integrated optical device 1 includes a wavelength dividing structure 10, a second structure 200 and a substrate 300. The wavelength dividing structure 10 and the second structure 200 are disposed over the substrate 300 and laterally connected with each other. The wavelength dividing structure 10 in FIG. 15 may be the wavelength dividing structure 10A shown in FIGS. 1-3, the wavelength dividing structure 10B shown in FIGS. 5-7 or the like, which is not limited thereto. The output waveguides (including the first output waveguides 110c and the second output waveguides 110d) of the wavelength dividing structure 10 are physically connected with the connecting waveguides 210 of the second structure 200. In some embodiments, the cladding structure 120 is physically connected with the dielectric layer 220 of the second structure 200.

In some embodiments, the second structure 200 may include photonic integrated circuit (PIC) layers, and the connecting waveguides 210 may be a portion of the PIC layers. In this way, the light entering from the input waveguide 110b of the wavelength dividing structure 10 can be divided into multiple beams through the wavelength dividing body 110a, and the multiple beams are transferred from the output waveguides 110c and 110d to the connecting waveguides 210 for further signal processing in the second structure 200, and vice versa.

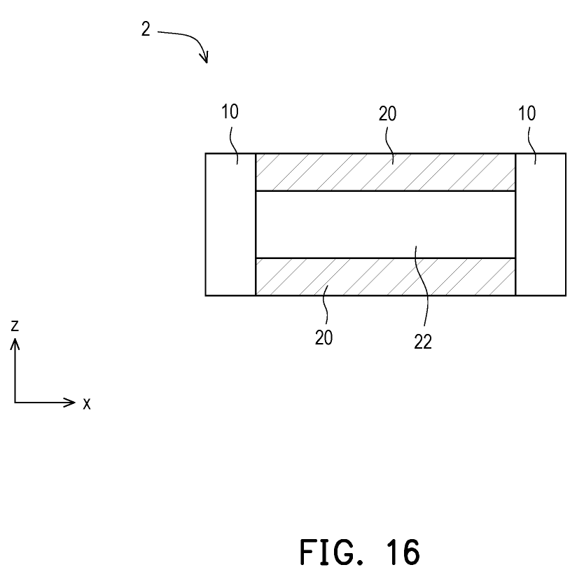

FIG. 16 is a schematic cross-sectional view of an integrated optical device 2 according to an embodiment of the present disclosure. For clarity, FIG. 16 does not illustrate detail of the wavelength dividing structures 10, and the structure of the wavelength dividing structures 10 may be referred to the aforementioned embodiments.

Referring to FIG. 16, an integrated optical device 2 includes wavelength dividing structures 10 and photonic integrated circuit (PIC) layers 20. The PIC layers 20 are optically connected between the wavelength dividing structures 10. The wavelength dividing structure 10 in FIG. 15 may be the wavelength dividing structure 10A shown in FIGS. 1-3, the wavelength dividing structure 10B shown in FIGS. 5-7 or the like, which is not limited thereto. Since the wavelength dividing structure 10 is a three-dimensional structure, the PIC layers 20 may be arranged along the thickness direction (i.e. z direction) and connected to the same wavelength dividing structure 10. This allows for more efficient use of vertical space, making the arrangement of devices more compact and thereby increasing the device density.

In some embodiments, the PIC layers 20 may include connecting waveguides similar as the connecting waveguides 210 shown in FIG. 15, optical devices (not shown, such as photo detectors, optical modulators, photodiode or the like) or the like.

In some embodiments, a dielectric layer 22 is located between adjacent PIC layers 20 to optically isolate the adjacent PIC layers 20. The dielectric layer 22 may have a refractive index lower than the refractive index of the PIC layers 20. In some embodiments, the material of the dielectric layer 22 includes silicon oxide or other suitable materials.

The present disclosure enables the design of multiple layers of PIC connected each other by 3D wavelength dividing structure. This significantly increases the density and functionality per die area, allowing for more efficient use of space and enhanced performance.

FIG. 16 schematically shows two wavelength dividing structures 10, two PIC layers 20 and one dielectric layer 22, but the present disclosure is not limited thereto. The numbers of the wavelength dividing structures 10 and PIC layers 20 and dielectric layer 22 are not limited by the disclosure and can be adjusted based on actual requirements.

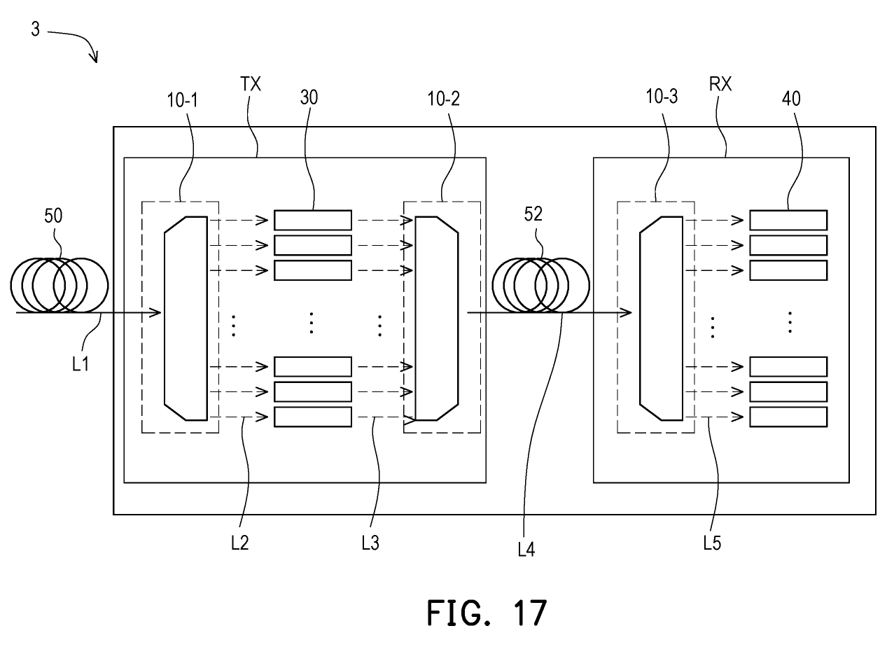

FIG. 17 is a diagram of an integrated optical device 3 according to an embodiment of the present disclosure.

Referring to FIG. 17, an integrated optical device 3 includes a transmitter TX and a receiver RX. The transmitter TX is optically coupled to the receiver RX through an optical fiber 52. The transmitter TX includes a first wavelength dividing structure 10-1, electro-optical modulators 30 and a second wavelength dividing structure 10-2. The first wavelength dividing structure 10-1 is a demultiplexer configured to divide a single optical beams with a broadband wavelength into multiple optical beams with different narrow central wavelengths. The second wavelength dividing structure 10-2 is a multiplexer configured to combine multiple optical beams with different narrow central wavelengths into a single optical beams with a broadband wavelength. The electro-optical modulators 30 are optically coupled between the first wavelength dividing structure 10-1 and the second wavelength dividing structure 10-2 and are configured to modulate optical beams into optical signals. For example, data may be encoded into the optical beams by modulating the light into optical pulses through electro-optical modulators 30. The receiver RX includes a third wavelength dividing structure 10-3 and photodetectors 40. The third wavelength dividing structure 10-3 is a demultiplexer configured to divide a single optical beams with a broadband wavelength into multiple optical beams with different narrow central wavelengths. The photodetectors 40are optically coupled to the third wavelength dividing structure 10-3 and are configured to convert the received optical signals into electrical signals.

In some embodiments, the first wavelength dividing structure 10-1 may receive a light beam L1 from a light source (not shown) through an optical fiber 50. The light beam L1 is divided into multiple light beams L2 through the first wavelength dividing structure 10-1. The light beams L2 each enter the corresponding electro-optical modulators 30 through connecting waveguides (not shown), are modulated to carry signals and are output from the electro-optical modulators 30 as light beams L3. Then the light beams L3 are transferred to the second wavelength dividing structure 10-2 through connecting waveguides (not shown) to combine the multiple light beams L3 into a single light beam L4 for easy transmission. The light beam L4 is propagated in the optical fiber 52 and enters the third wavelength dividing structure 10-3. The third wavelength dividing structure 10-3 divides the light beam L4 into multiple light beams L5. The light beams L5 each enter the corresponding photodetectors 40 through connecting waveguides (not shown), so that the optical signals carried by the light beams L5 may be converted to electrical signals by the photodetectors 40. In this way, data in the transmitter TX can be carried by optical beams of different wavelengths which may be divided or combined through the wavelength dividing structures 10-1, 10-2 and 10-3 for the efficient transmission. Finally, the optical signals may be converted to electrical signals in the receiver RX for further signal processing.

In FIG. 17, the first wavelength dividing structure 10-1, the second wavelength dividing structure 10-2 and the third wavelength dividing structure 10-3 may be similar to the wavelength dividing structure 10A shown in FIGS. 1-3, the wavelength dividing structure 10B shown in FIGS. 5-7 or the like, which is not limited thereto. The number of the output waveguides of the first wavelength dividing structure 10-1, the number of the input waveguides of the second wavelength dividing structure 10-2 and the number of the electro-optical modulators 30 are not limited by the disclosure, as long as the number of the output waveguides of the first wavelength dividing structure 10-1, the number of the input waveguides of the second wavelength dividing structure 10-2 and the number of the electro-optical modulators 30 are matched. Besides, the output waveguides of the first wavelength dividing structure 10-1 may be arranged at different horizontal levels as the aforementioned embodiments. The positions of electro-optical modulators 30 and the input waveguides of the second wavelength dividing structure 10-2 correspond to the output waveguides of the first wavelength dividing structure 10-1 for optical transmission.

On the other hand, the number of the output waveguides of the third wavelength dividing structure 10-3 and the number of the photodetectors 40 are not limited by the disclosure, as long as the number of the output waveguides of the third wavelength dividing structure 10-3 and the number of the photodetectors 40 are matched. Besides, the output waveguides of the third wavelength dividing structure 10-3 may be arranged at different horizontal levels as the aforementioned embodiments. The positions of the photodetectors 40 are corresponding to the output waveguides of the third wavelength dividing structure 10-3 for optical transmission.

In view of the above, the present disclosure allows for an increase in the number of connected waveguides to the wavelength dividing structure without enlarging the footprint. In traditional practices, the footprint of the conventional wavelength dividing structure needs to be enlarged to accommodate more wavelength divisions or additional waveguides. In contrast, the present disclosure maintains the same footprint but increases the number of wavelength divisions or connected waveguides by increasing the thickness of the 3D structure. Therefore, the vertical space is efficiently utilized, and the size of the wavelength dividing structure and therefore the integrated optical device can be significantly reduced.

In accordance with some embodiments, a method includes the following steps. A porous structure is formed by assembling a plurality of bricks, wherein the porous structure includes a continuous hollow portion within a bulk material. A first material having a first refractive index is filled into the continuous hollow portion of the porous structure. The bulk material of the porous structure is replaced with a second material having a second refractive index. The second refractive index is less than the first refractive index.

In accordance with another embodiments, a method includes the following steps. A first structure including a hollow portion within a bulk material is provided. The hollow portion includes a wavelength dividing channel, an input channel connected to one side of the wavelength dividing channel and multiple output channels connected to an opposite side of the wavelength dividing channel. The bulk material has a plurality of first connection parts. A second structure over a substrate is provided, wherein the second structure has a plurality of second connection parts. The first structure connects to the second structure through the plurality of first connection parts and the second connection parts.

In accordance with yet another embodiment of the disclosure, a device is described. The device includes a wavelength dividing structure including a wavelength dividing body configured to split an input beam into multiple output beams, an input waveguide connecting to one side of the wavelength dividing body, at least two first output waveguides connecting to an opposite side of the wavelength dividing body and at least two second output waveguides connecting to the opposite side of the wavelength dividing body and located above the at least two first output waveguides.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
forming a porous structure by assembling a plurality of bricks, wherein the porous structure comprises a continuous hollow portion within a bulk material;
filling a first material having a first refractive index into the continuous hollow portion of the porous structure; and
replacing the bulk material of the porous structure with a second material having a second refractive index,
wherein the second refractive index is less than the first refractive index.

2. The method of claim 1, wherein a method of replacing the bulk material of the porous structure comprises:
removing the bulk material from the porous structure.

3. The method of claim 2, wherein the method of replacing the bulk material of the porous structure further comprises:
depositing the second material to form a cladding structure surrounding the first material.

4. The method of claim 1, wherein the plurality of bricks is assembled by chemical bonding.

5. The method of claim 1, wherein the plurality of bricks is assembled by mechanical engagement.

6. The method of claim 1, wherein the continuous hollow portion of the porous structure comprises a wavelength dividing channel.

7. The method of claim 6, wherein the continuous hollow portion of the porous structure further comprises:
an input channel connected to one side of the wavelength dividing channel; and
multiple output channels connected to an opposite side of the wavelength dividing channel.

8. A method, comprising:
providing a first structure comprising a hollow portion within a bulk material, wherein the hollow portion comprises:
a wavelength dividing channel;
an input channel connected to one side of the wavelength dividing channel; and
multiple output channels connected to an opposite side of the wavelength dividing channel, wherein the bulk material has a plurality of first connection parts;
providing a second structure over a substrate, wherein the second structure has a plurality of second connection parts; and
connecting the first structure to the second structure through the plurality of first connection parts and the second connection parts.

9. The method of claim 8, wherein the hollow portion is a continuous hollow portion.

10. The method of claim 8, wherein a size of the hollow portion is about 50 nm or more.

11. The method of claim 8, wherein each first connection part has a first single-strand DNA, and each second connection part has a second single-strand DNA, and the first single-strand DNA and the second single-strand DNA are paired.

12. The method of claim 8, further comprising, after connecting the first structure to the second structure, filling a first material having a first refractive index in the wavelength dividing channel, the input channel and the output channels, so as to form a wavelength dividing body in the wavelength dividing channel, an input waveguide in the input channel, and output waveguides in the output channels.

13. The method of claim 12, further comprising, after filling the first material, replacing the bulk material of the first structure with a second material having a second refractive index to form a cladding structure, wherein the second refractive index is less than the first refractive index.

14. The method of claim 8, wherein the second structure comprises a plurality of connecting waveguides formed in a dielectric layer, wherein the connecting waveguides correspond to the output channels of the first structure.

15. A device, comprising:
a wavelength dividing structure comprising:
a wavelength dividing body configured to split an input beam into multiple output beams;
an input waveguide connecting to one side of the wavelength dividing body;
at least two first output waveguides connecting to an opposite side of the wavelength dividing body; and
at least two second output waveguides connecting to the opposite side of the wavelength dividing body and located above the at least two first output waveguides.

16. The device of claim 15, wherein the input waveguide is configured to transfer a wavelength broadband beam, and the at least two first output waveguides and the at least two second output waveguides are configured to transfer wavelength narrowband beams.

17. The device of claim 15, wherein the wavelength dividing structure further comprises:
a cladding structure surrounding the wavelength dividing body, the input waveguide, the at least two first output waveguides and the at least two second output waveguides,
wherein a refractive index of the cladding structure is less than a refractive index of the wavelength dividing body.

18. The device of claim 17, wherein a material of the cladding structure comprises nucleic acids, air, or silicon oxide.

19. The device of claim 15, wherein a material of the wavelength dividing body comprises silicon or silicon nitride.

20. The device of claim 15, wherein the wavelength dividing body comprises a plurality of three-dimensional optical paths connected to each other.
